(19) United States
(12) Patent Application Publication
(10) Pub. No.: US 2003/0047557 A1
(43) Pub. Date: Mar. 13, 2003

(54) ELECTRIC HEATER WITH LOW ELECTROMAGNETIC WAVE EFFECT

(75) Inventor: Yen-Fa Chen, Nei-Hu (TW)

Correspondence Address: BACON & THOMAS, PLLC, 625 SLATERS LANE, FOURTH FLOOR, ALEXANDRIA, VA, 22314

(73) Assignee: Petatech Co., Ltd., Taiwan (TW)

(21) Appl. No.: 09/950,677

(22) Filed: Sep. 13, 2001

(51) Int. Cl. H05B 3/00

(52) U.S. Cl. 219/552; 219/544; 219/528

(57) ABSTRACT

An electric heater with a low electromagnetic wave effect, the heater is mainly used to generate heat in a main pipe line, and is provided with a loop line and an electric heating line laid juxtaposed and parallel with each other with a suitable distance therebetween; by serially connecting the ends respectively of the loop line and the electric heating line as well as coupling the other ends respectively of the loop line and the electric heating line with the electric current loop of an electric source, when electric current flows through the loop line and the electric heating line, the current flows therethrough in a contrary direction to offset most of electromagnetic waves; in this way, the electromagnetic wave effect of the electric heater is effectively lowered.

### BACKGROUND OF THE INVENTION

1. Field of the Invention

The present invention is related to an electric heater with a low electromagnetic wave effect, and especially to an electric heater to effectively lower electromagnetic wave effect and thereby effectively lower damage of an electric heater to human bodies due to the electromagnetic wave effect.

2. Description of the Prior Art

In using a general electric appliance, electromagnetic waves can be generated by transmitting of the internal electric current, strength of electromagnetic waves of every electric appliance can be different, however, according to many reports of study presently, human bodies will be damaged by electromagnetic waves; the longer or the nearer the electromagnetic wave effect exists, the larger the damage will be. People cannot help noticing the electromagnetic wave effect induced by various electric equipments.

Among the electric appliances, electric blankets or electric mats or the like get the most chances to direct and long contact human bodies. Particularly, the bodies of such kind of electric appliances are full of heating electric resistance to generate heat sources. The cause that the heating electric resistance generates a heat source is, the action of impedance of the electric resistance transform partial electric energy into heat energy which forms the heat source. And within the scope of the heating electric resistance, passage of electric current can generate an electromagnetic wave effect adequate to influence human bodies. A user in a long and direct contact with an electric heater will be damaged quite a degree by the electromagnetic wave effect.

### SUMMARY OF THE INVENTION

The primary object of the present invention is to provide an electric heater with a low electromagnetic wave effect, by providing mutually spaced, parallel and juxtaposed loop line and electric heating line in the main pipe line which forms the heating action, and by serially connecting the ends respectively of the loop line and the electric heating line as well as coupling the other ends respectively of the loop line and the electric heating line with the electric current loop of an electric source, when electric current flows through the loop line and the electric heating line, the current flows therethrough in a contrary direction to offset most of the electromagnetic waves. In this way, the electromagnetic wave effect of the electric heater can be effectively lowered.

The present invention will be apparent after reading the detailed description of the preferred embodiments thereof in reference to the accompanying drawings.

### BRIEF DESCRIPTION OF THE DRAWINGS

FIG. 1 is a perspective view showing the appearance of an electric heater of the present invention;

FIG. 2 is an analytic perspective view of the present invention;

FIG. 3 is a schematic perspective view showing the electric current direction of the present invention;

FIG. 4 is a sectional view of showing the structure of an insulating member of the present invention;

FIG. 5 is a sectional view showing the structure of another insulating member of the present invention.

### DETAILED DESCRIPTION OF THE PREFERRED EMBODIMENT

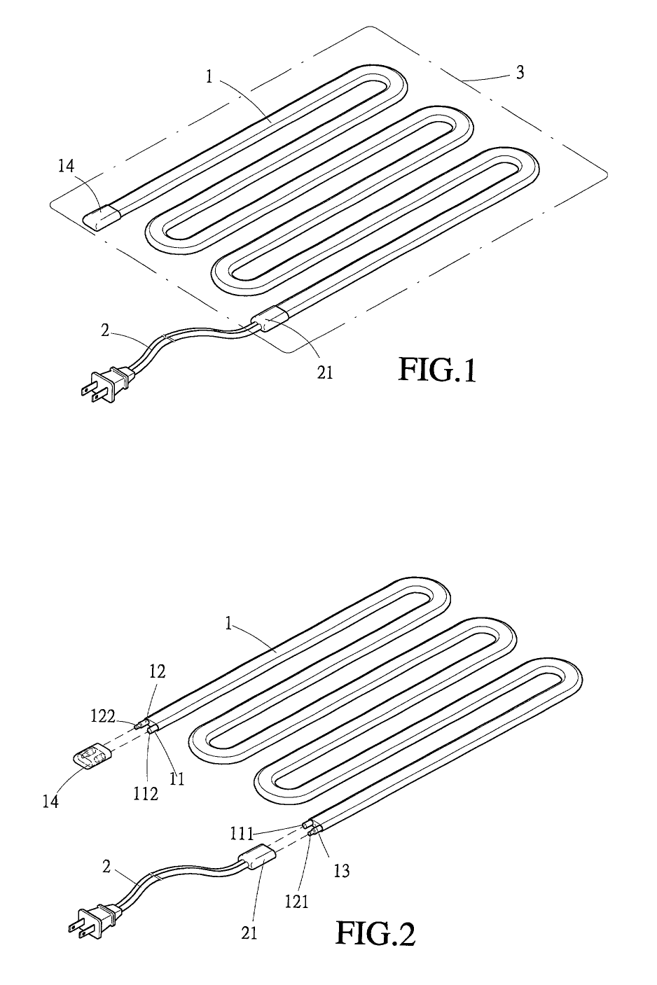

Referring to FIG. 1, it can be seen that the electric heater with a low electromagnetic wave effect of the present invention is comprised of a main pipe line 1 with the function of a heating electric resistance resulting heat emitting, and is comprised of a body 3 of the heater, an electric source line 2 is coupled with the main pipe line 1 to supply electricity, and to complete an electric current loop, the heat source generated by the heating electric resistance in the main pipe line 1 makes the body 3 of the heater get the expected function of heat emitting.

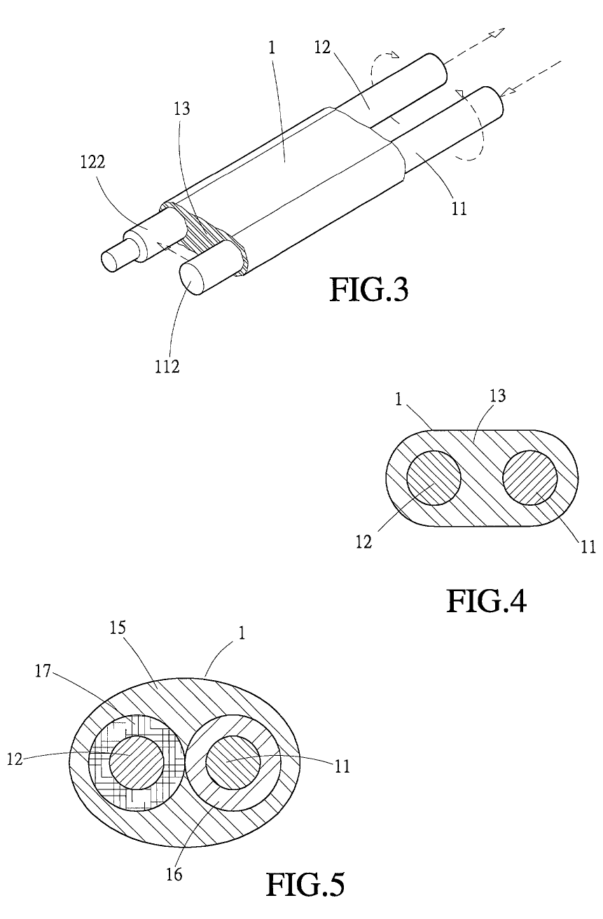

Referring to FIGS. 2 and 3 simultaneously, an electric heating line 12 and a loop line 11 are parallelly enveloped in the main pipe line 1, wherein, the electric heating line 12 is exactly the heating electric resistance to generate the heat source, while the loop line 11 functions mainly as the electric current loop between the electric source line 2 and the electric heating line 12. By virtue that the loop line 11 and the electric heating line 12 are parallelly juxtaposed with each other in the main pipe line 1, they form respectively on the two ends of the main pipe line 1 a first electric source end 111, a second electric source end 121 for coupling with the electric source line 2 and a first serial connecting end 112 and a second serial connecting end 122 for serially connecting with each other. The loop line 11 and the electric heating line 12 are firmly enveloped with an enveloping layer 13 to complete the structure of the main pipe line 1. The enveloping layer 13 provides insulation between the loop line 11 and the electric heating line 12, as shown in FIG. 4, to make a separation for electric current to keep the loop line 11 away from the electric heating line 12 a suitable distance.

In practical application of the entire electric heater, as shown in FIGS. 2 and 3, the firing line and the earthing line of the electric source line 2 are respectively coupled with the first electric source end 111 of the loop line 11 in the main pipe line 1 and the second electric source end 121 of the electric heating line 12; while the first serial connecting end 112 of the loop line 11 is lap jointed with the second serial connecting end 122 of the electric heating line 12. Therefore, when current flows through the electric source line 2 into the main pipe line 1, it will enter from the first electric source end 111 of the main pipe line 1, and arrive at the lap joint between the first serial connecting end 112 and the second serial connecting end 122 along the loop line 11. The current can thereby flows along the electric heating line 12 in a contrary direction to the second electric source end 121 and out of the electric heating line 12 to form a complete electric current loop. And when the current flows through the electric heating line 12, it is transformed into heat energy by the action of impedance to thereby form a heat source adequate to render the electric heater to emit heat. Especially when the current flows through the loop line 11 to get into the main pipe line 1 and then is put out from the main pipe line 1 via the electric heating line 12 in a contrary direction, the whole section of the main pipe line 1 can have most of its electromagnetic waves offset by the mutual contrary flowing of the current portions in the loop line 11 and the electric heating line 12, thereby, the electromagnetic wave effect of the main pipe line 1 can be effectively lowered, and damage of the electromagnetic wave effect to human bodies by the electric heater can be reduced.

Further as shown in FIGS. 1 and 2, the main pipe line 1 of the present invention can be made to have a corresponding length to meet the practical cut length required for the device 3 in use. One end of the main pipe line 1 is slipped thereover with a serially connecting member 14 able to make lap jointing of the first serial connecting end 112 with the second serial connecting end 122; while a coupling portion 21 is provided on one end of the electric source line 2, the coupling portion 21 makes coupling of the electric source line 2, the first electric source end 111 and the second electric source end 121; thereby, the practicality and scope of application of the entire electric heater can be increased. And as shown in FIG. 5, in manufacturing the main pipe line 1, the surfaces of the loop line 11 and the electric heating line 12 can be enveloped respectively with a first insulation layer 16 and a second insulation layer 17, and the loop line 11 and the electric heating line 12 are laid juxtaposed and parallel with each other, and are firmly enveloped with an insulating coating 15 to complete the structure of the main pipe line 1.

In the electric heater with a low electromagnetic wave effect of the present invention, by providing the mutually spaced, parallel and juxtaposed loop line and electric heating line, and by serially connecting the ends respectively of the loop line and the electric heating line as well as coupling the other ends respectively of the loop line and the electric heating line with the electric current loop of an electric source, when electric current flows through the loop line and the electric heating line, the current flows therethrough in a contrary direction to offset most of the electromagnetic waves. In this way, the electromagnetic wave effect of the electric heater can be effectively lowered. Therefore, electric heaters can get another structure which is better and practicable,

Having now particularly described and ascertained the nature of my invention and in what manner the same is to be performed, what we claim will be declared in the claims followed.

1. An electric heater with a low electromagnetic wave effect, said heater comprises a main pipe line with the function of a heating electric resistance that results heat emitting, and comprises a body of said heater, an electric source line is coupled with said main pipe line to supply electricity, and to complete an electric current loop, a heat source generated by said heating electric resistance in said main pipe line makes said body of said heater get the expected function of heat emitting; said heater is characterized by:
an electric heating line and a loop line are parallelly enveloped in said main pipe line, wherein, said electric heating line is exactly said heating electric resistance to generate said heat source, while said loop line functions as an electric current loop between said electric source line and said electric heating line; by serially connecting the ends respectively of said loop line and said electric heating line as well as coupling the other ends respectively of said loop line and said electric heating line with the electric current loop of an electric source, when electric current flows through said loop line and said electric heating line, said current flows therethrough in a contrary direction to offset most of electromagnetic waves; in this way, said electromagnetic wave effect of said electric heater is effectively lowered.

2. An electric heater with a low electromagnetic wave effect as in claim 1, wherein,
said loop line and said electric heating line are identical by length.

3. An electric heater with a low electromagnetic wave effect as in claim 1, wherein,
said loop line and said electric heating line form respectively on the two ends of said main pipe line a first electric source end and a second electric source end for coupling with said electric source line as well as a first serial connecting end and a second serial connecting end for serially connecting with each other.

4. An electric heater with a low electromagnetic wave effect as in claim 3, wherein,
one end of said main pipe line is slipped thereover with a serially connecting member able to make lap jointing of said first serial connecting end with said second serial connecting end.

5. An electric heater with a low electromagnetic wave effect as in claim 3, wherein,
a coupling portion is provided on one end of said electric source line, said coupling portion makes coupling of said electric source line, said first electric source end and said second electric source end.

6. An electric heater with a low electromagnetic wave effect as in claim 4, wherein,
a coupling portion is provided on one end of said electric source line, said coupling portion makes coupling of said electric source line, said first electric source end and said second electric source end.

7. An electric heater with a low electromagnetic wave effect as in claim 1, wherein,
said loop line is formed directly from core wires in said electric source line.

8. An electric heater with a low electromagnetic wave effect as in claim 1, wherein,
surfaces of said loop line and said electric heating line are enveloped respectively with a first insulation layer and a second insulation layer, said loop line and said electric heating line are laid juxtaposed and parallel with each other, and are firmly enveloped with an insulating coating to complete the structure of said main pipe line.
